(19) United States
(12) Patent Application Publication
(10) Pub. No.: US 2003/0230084 A1
(43) Pub. Date: Dec. 18, 2003

(54) ACTUATING DEVICE FOR A HYDRAULIC LIFTING DEVICE

(76) Inventors: Kun-Jui Tang, Tainan (TW); Su-Chen Liang, Yungkang City (TW)

Correspondence Address: VARNDELL & VARNDELL, PLLC, 106-A S. COLUMBUS ST., ALEXANDRIA, VA, 22314, US

(21) Appl. No.: 10/167,617

(22) Filed: Jun. 13, 2002

(51) Int. Cl. F16D 31/02

(52) U.S. Cl. 60/477

(57) ABSTRACT

An actuating device for a hydraulic lifting device has a body, a piston and a lever. The body has an inlet channel communicating with an oil tank and an outlet channel connected to a cylinder. The piston is moveably received in the body to divide a chamber into an upper chamber and a lower chamber that communicates with the inlet channel and the outlet channel in the body. Two check valves are respectively received in the inlet channel and the outlet channel in the body. A slight gap is defined between the periphery of the piston and the inner surface of the chamber in the body. Accordingly, some oil in the lower chamber is allowed to flow into the upper chamber when the pressure in the outlet channel is over a desired level, and the structure of the actuating device is simple.

### BACKGROUND OF THE INVENTION

1. Field of the Invention

The present invention relates to an actuating device, and more particularly to a rapid actuating device for a hydraulic lifting device and having a simplified structure.

2. Description of Related Art

With reference to FIG. 6, a conventional actuating device for a hydraulic lifting device comprises a body (70), a first piston (80), a second piston (82) and a lever (76). An inlet channel (71) is defined in the body (70) to communicate with an oil tank (90) attached to the body (70), and an outlet channel (72) is defined in the body (70) to be connected to a cylinder (not shown). The first piston (80) is secured in the body (70) and has a rod. The second piston (82) is moveably mounted in the body (70). A recess (not numbered) is defined in the bottom of the second piston (82) for the rod on the first piston (80) to extend into the recess. Consequently, a first chamber (74) and a second chamber (742) are respectively defined in the body (70) and the second piston (82). A first inlet passage (802) and a second inlet passage (804) are defined in the first piston (80) and communicate with the inlet channel (71) in the body (70). The first and second inlet passages (802,804) in the first piston (80) are respectively communicated with the first chamber (74) and the second chamber (742). A first outlet passage (806) and a second outlet passage (808) are defined in the first piston (80) and communicate with the outlet channel (72) in the body (70). The first and second outlet passages (806,808) in the first piston (80) are respectively communicated with the first chamber (74) and the second chamber (742). A check valve (not numbered) is mounted in each respective passage (802,804,806,808) in the first piston (80). In addition, a branch passage (809) is defined in the first piston (80) and communicates with the first outlet passage (806) and the inlet channel (71). A control valve (not numbered) is mounted in the branch passage (809).

The lever (76) is pivotally attached to the body (70) and is connected to the top end of the second piston (82). When the lever (76) is rotated upward relative to the body (70), the second piston (82) is pulled upward relative to the body (70). Consequently, the first chamber (74) and the second chamber (742) will be simultaneously enlarged, and the pressure in the chambers (74,742) will be reduced. The oil in the tank (90) can be sucked into the chambers (74,742) through the inlet channel (71) and the inlet passages (802,804) in the first piston (80). When the lever (76) is rotated downward relative to the body (70), the oil in the chambers (74,742) will be pushed into the outlet channel (72) through the outlet passages (806,808) in the first piston (80) and fed to the cylinder.

When the cylinder is applied to lift a light loading, the oil in the chambers (74,742) can be fully pushed into the outlet channel (72) and can be completely fed into the cylinder. Consequently, the lifting speed of the cylinder is rapid. When the cylinder is applied to lift a heavy loading, a high pressure will occur in the outlet channel (72). The oil in the first chamber (74) will not pass through the check valve in the first outlet passage (806) due to the high pressure in the outlet channel (72). The oil in the first chamber (806) will pass through the control valve in the branch passage (809) and will flow back to the oil tank (90) through the inlet channel (71). Only the oil in the second chamber (742) will be applied into the outlet channel (742) and fed into the cylinder, such that the lifting speed of the cylinder is slow. Accordingly, the lift speed will automatically vary according to the loading on the cylinder.

However, the structure of the conventional actuating device is very complex, and to manufacture and assemble the conventional actuating device are both very troublesome and difficult. Thus, the cost for manufacturing the conventional actuating device is expensive.

To overcome the shortcomings, the present invention tends to provide an actuating device to mitigate or obviate the aforementioned problems.

### SUMMARY OF THE INVENTION

The main objective of the invention is to provide an actuating device for a hydraulic lifting device and that has a simplified structure. The actuating device has a body, a piston and a lever. The body has an inlet channel communicating with an oil tank and an outlet channel connected to a cylinder. A chamber is defined in the body. The piston is moveably received in the body to divide the chamber into an upper chamber and a lower chamber that communicates with the inlet channel and the outlet channel in the body. The piston has a piston rod extending out from the body. Two check valves are respectively received in the inlet channel and the outlet channel in the body. The lever is pivotally attached to the body and connected to the piston rod to actuate the piston rod to move relative the chamber in the body. A slight gap is defined between the periphery of the piston and the inner surface of the chamber in the body. Accordingly, some oil in the lower chamber is allowed to flow into the upper chamber when the pressure in the outlet channel is over a desired level, thus the quantity of oil applied to the cylinder will be automatically varied according to the loading on the cylinder.

Other objects, advantages and novel features of the invention will become more apparent from the following detailed description when taken in conjunction with the accompanying drawings.

### BRIEF DESCRIPTION OF THE DRAWINGS

FIG. 1 is a plan view in partial cross section of an actuating device for a hydraulic lifting device in accordance with the present invention;

FIG. 2 is an operational plan view in partial cross section of the actuating device in FIG. 1 showing that the oil in the oil tank is sucked into the lower chamber through the inlet channel in the body;

FIG. 3 is an operational plan view in partial cross section of the actuating device in FIG. 1 showing that the oil in the lower chamber is pushed into the outlet channel;

FIG. 4 is a side plan view of a releasing valve in the actuating device in FIG. 1;

FIG. 5 is a side plan view of a safety valve in the actuating device in FIG. 1; and

FIG. 6 is a side plan view in partial cross section of a conventional actuating device for a hydraulic lifting device in accordance with the prior art.

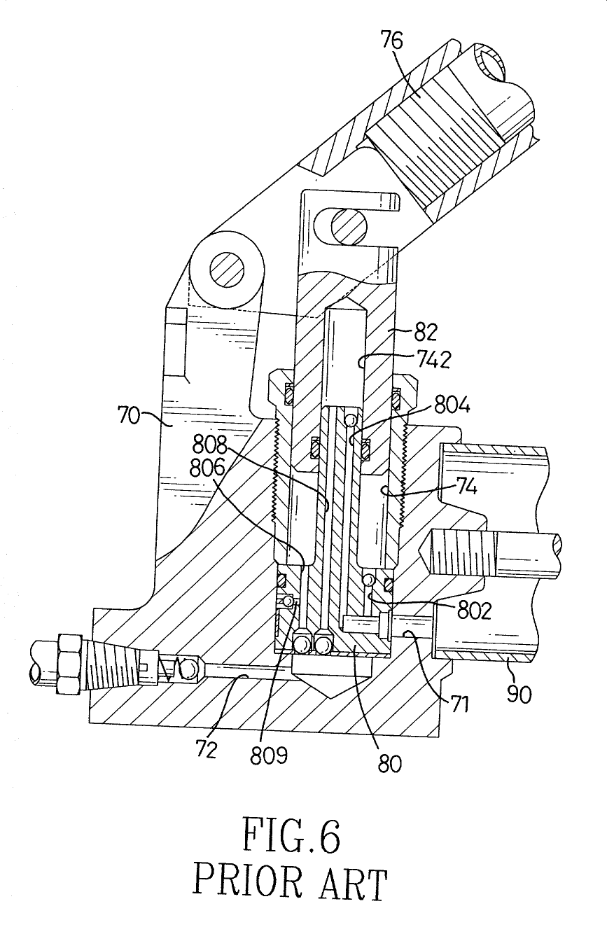

### DETAILED DESCRIPTION OF PREFERRED EMBODIMENT

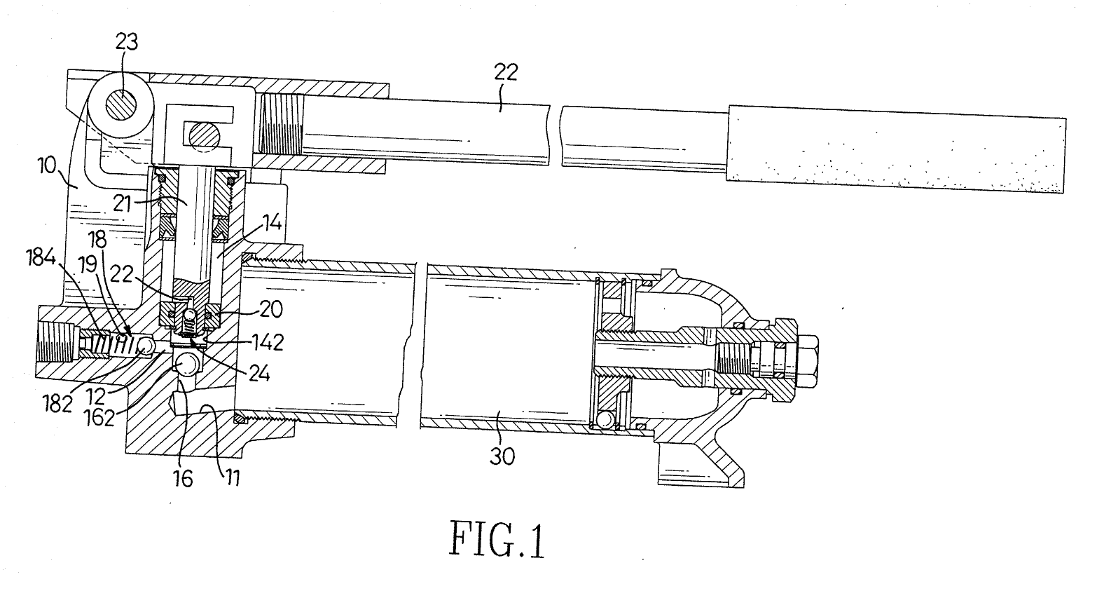

With reference to FIG. 1, an actuating device for a hydraulic lifting device in accordance with the present invention comprises a body (10), a piston (20) and a lever (22). An inlet channel (11) is defined in the body (10) to communicate with an oil tank (30) attached to the body (10). An outlet channel (12) is defined in the body (10) and is connected to a cylinder (not shown). A main chamber is defined in the body (10) for receiving the piston (20).

The piston (20) is moveably received in the main chamber in the body (10) and divides the main chamber into an upper chamber (14) and a lower chamber (142). Wherein, the lower chamber (142) communicates with the inlet channel (11) and the outlet channel (12) in the body (10), and a slight gap is defined between the periphery of the piston (20) and the inner surface of the main chamber in the body (10). A piston rod (21) is mounted on the piston (20) and extends out from the body (10).

A first check valve (16) is received in the lower chamber (142) to control a direction of oil flow between the inlet channel (11) and the lower chamber (142). In practice, the first check valve (16) is a steel ball (162) abutting the conjunction between the lower chamber (142) and the inlet channel (11) to close the inlet channel (11). A second check valve (18) is received in the outlet channel (12) to control a direction of oil flow between the outlet channel (12) and the lower chamber (142). The second check valve (18) comprises a steel ball (182) abutting the conjunction between the lower chamber (142) and the outlet channel (12) and a spring (184) abutting the steel ball (182).

The lever (22) is pivotally attached to the body (10) with a pivot (23) and is connected to the piston rod (21) to actuate the piston (20) with the piston rod (21) to move relative to the main chamber in the body (10).

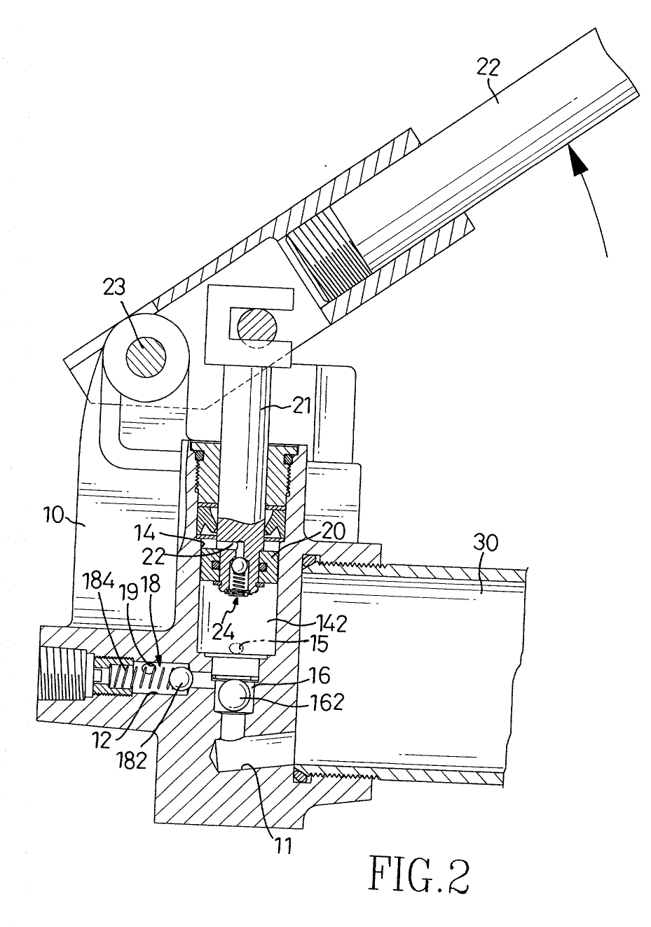

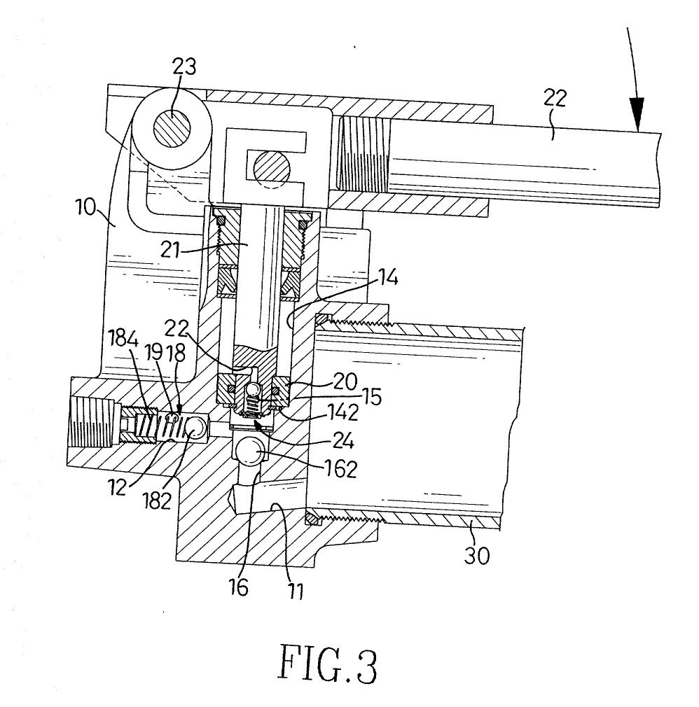

With reference to FIGS. 2 and 3, when the lever (22) is rotated upward relative to the body (10), the piston rod (21) is pulled upward and the piston (20) moves upward along the main chamber in the body (10). The lower chamber (142) is enlarged and the upper chamber (14) is reduced, and the pressure in the lower chamber (142) is reduced. The oil in the tank (30) can be sucked into the lower chamber (142) through the inlet channel (11) and the first check valve (16). When the lever (22) is rotated downward relative to the body (10), the oil in the lower chamber (142) will be pushed into the outlet channel (12) through the second check valve (12) and fed to the cylinder.

During the operation of the piston (20), some oil will be contained in the slight gap between the piston (20) and the main chamber in the body (10). A good sealing effect can be provided to the piston (20) and the main chamber in the body (10) due to the surface tension of the oil. When the pressure in the lower chamber (142) is under a desired level that can overcome surface tension of the oil to allow the oil to pass through the gap, all of the oil in the lower chamber (142) will be pushed into the outlet channel (12) and be fed into the cylinder.

When the pressure in the lower chamber (142) is over the desired level, some of the oil will pass through the slight gap and flow into the upper chamber (14), and the quantity of oil fed into the cylinder is reduced.

Therefore, when the cylinder is used to lift a light loading and the pressure in the outlet channel (12) is under the desired level, the oil sucked into the lower chamber (142) can be completely applied to the cylinder and the lifting speed of the cylinder is rapid.

When the cylinder is used to lift a heavy loading and the pressure in the outlet channel (12) is over the desired level, some of the oil will flow into the upper chamber (14) and the other oil will be applied to the cylinder. Consequently, the cylinder will lift the heavy loading at a lower speed but with a high-pressure level, such that the lifting speed of the cylinder will be automatically adjusted according to the loading on the cylinder. With such the actuating device, the structure of the actuating device is simplified, and the cost for manufacturing the actuating is reduced.

In addition, with reference to FIGS. 1 to 3, a feedback channel (22) is defined in the piston (20) and communicates with the upper chamber (14) and the lower chamber (142). A third check valve (24) is mounted in the feedback channel (22) to allow the oil in the upper chamber (14) to flow into the lower chamber (142). Accordingly, when the piston (20) is actuated to move upward relative to the body (10), the oil flowing into the upper chamber (14) can flow back into the lower chamber (142) through the feedback channel (22) and the third check valve (24).

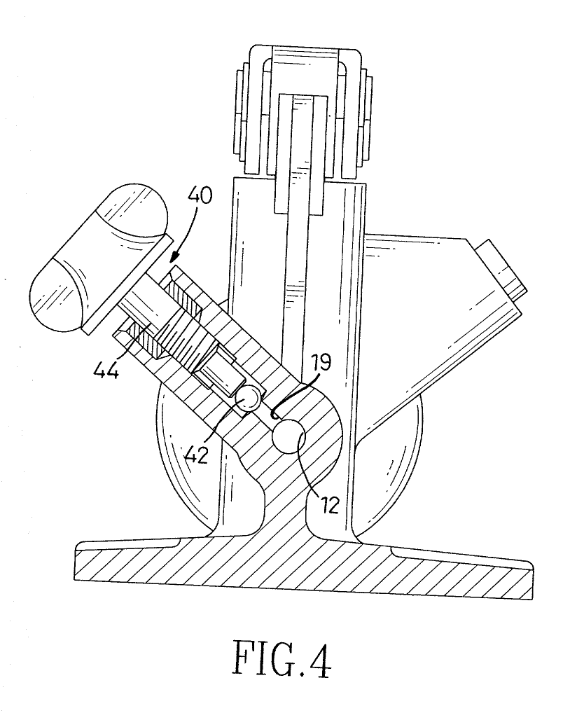

With reference to FIGS. 1 and 4, a releasing valve (40) is mounted in the body (10) to release the oil in the outlet channel (12) to the oil tank (30). A releasing channel (19) is defined in the body (10) and communicates with the outlet channel (12) and the oil tank (30), and the releasing valve (40) is received in the releasing channel (19). The releasing valve (40) comprises a steel ball (42) closing the releasing channel (19) and a releasing screw (44) abutting the steel ball (42). When the releasing screw (44) is rotated to leave a position where it abuts the steel ball (42), such that the steel ball (42) will be pushed to leave a position where it closes the releasing channel (19) by the hydraulic pressure in the outlet channel (12). Consequently, the oil in the outlet channel (12) and the oil fed into the cylinder will flow back to the oil tank (30) through the releasing channel (19).

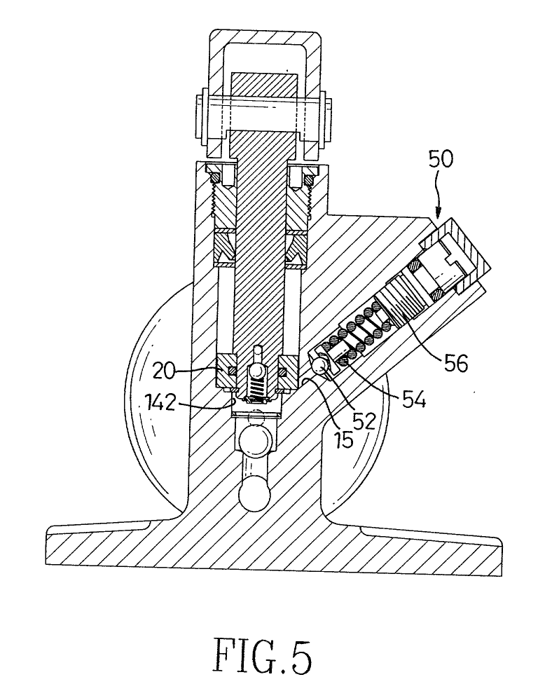

With reference to FIGS. 1 and 5, a safety valve (50) is mounted in the body (10) to keep the hydraulic pressure in the lower chamber (142) under a desired level. A safety channel (15) is defined in the body (10) and communicates with the lower chamber (142) and the oil tank (30), and the safety valve (50) is received in the safety channel (15). The safety valve (50) comprises a steel ball (52) closing the safety channel (15), a spring (54) abutting the steel ball (52) and an adjusting screw (56) screwed in the body (10) and abutting the spring (54). When the pressure in lower chamber (142) is larger than the tension of the spring (54), the steel ball (52) will be pushed away from a position where it closes the safety channel (15) by the hydraulic pressure in the lower chamber (142). Consequently, the oil in the lower chamber (142) will flow back to the oil tank (30) through the safety channel (15) to avoid the pressure in the lower chamber (142) from being over the desired level. To rotate the adjusting screw (56), the tension of the spring (54) is changed and the desired pressure level for the lower chamber (142) is adjusted.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An actuating device for a hydraulic lifting device comprising:
a body having an inlet channel adapted to communicate with an oil tank of the lift device, an outlet channel adapted to be connected to a cylinder of the lifting device and a chamber defined in the body;
a piston with a piston rod moveably received in the chamber in the body to divide the chamber into an upper chamber and a lower chamber that communicates with the inlet channel and the outlet channel in the body, the piston rod having a first end extending out from the body;
a lever pivotally attached to the body and connected to the first end of the piston rod to actuate the piston rod to move relative to the chamber in the body;
a first check valve received in the lower chamber to control a direction of oil flow between the inlet channel and the lower chamber; and
a second check valve received in the outlet channel to control a direction of oil flow between the outlet channel and the lower chamber,
wherein a slight gap is defined between a periphery of the piston and an inner surface of the chamber in the body and for containing oil in the gap,
whereby some oil in the lower chamber is allowed to flow into the upper chamber when pressure in the outlet channel is over a desired level.

2. The actuating device as claimed in claim 1, wherein the first check valve is a steel ball abutting a conjunction between the lower chamber and the inlet channel to close the inlet channel.

3. The actuating device as claimed in claim 1, wherein the second check valve comprises:
a steel ball abutting a conjunction between the lower chamber and the outlet channel; and
a spring abutting the steel ball to push the steel ball to close the outlet channel.

4. The actuating device as claimed in claim 1 further comprising a feedback channel defined in the piston and communicating with the upper chamber and the lower chamber; and
a third check valve mounted in the feedback channel to allow the oil in the upper chamber to flow into the lower chamber.

5. The actuating device as claimed in claim 1 further comprising a releasing channel defined in the body, communicating with the outlet channel and adapted to communicate with the oil tank; and
a releasing valve received in the releasing channel to allow the oil in the outlet channel to release back to the oil tank.

6. The actuating device as claimed in claim 5, wherein the releasing valve comprises:
a steel ball received in the releasing channel to close the releasing channel; and
a releasing screw screwed into the body and having an end abutting the steel ball.

7. The actuating device as claimed in claim 1 further comprising a safety channel defined in the body, communicating with the lower chamber and adapted to communicate with the oil tank; and
a safety valve mounted in the body to control a pressure in the lower chamber under a desired level.

8. The actuating device as claimed in claim 7, wherein the safety valve comprises:
a steel ball received in the safety channel to close the safety channel;
a spring received in the safety channel and having a first end abutting the steel ball and a second end; and
an adjusting screw screwed into the body and abutting the second end of the spring.
